(19) United States
(12) Patent Application Publication
(10) Pub. No.: US 2010/0312714 A1
(43) Pub. Date: Dec. 9, 2010

(54) MULTI-FACET PROFILE CREATION, MANAGEMENT AND SHARING OVER SOCIAL NETWORKS

(76) Inventor: Jean Dobey Ourega, Verdun (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/477,650

(22) Filed: Jun. 4, 2009

(51) Int. Cl. G06Q 99/00; G06F 17/30

(52) U.S. Cl. 705/319; 707/E17.044

(57) ABSTRACT

There is provided a method for customizing a relationship between members of a social network based on a multi-facet member profile, the method comprising: receiving profile data associated with a member; segregating at least a part of the profile data into a plurality of identifiable profile facets, and storing data records associated therewith in a multi-facet profile database; receiving from the member relationship parameters comprising: an identification of at least one other member of the social network, an identification of at least one profile facet among the identifiable profile facets, and sharing parameters defining access privileges to the at least one profile facet by the at least one other member; and based on the relationship parameters, storing in a relationship database data records allowing for determining, for each one of the at least one other member, access privileges associated with each one of the at least one profile facet. There is also provided a system for customizing a relationship between members of a social network based on a multi-facet member profile and a system for managing sharing of information over a social network.

### FIELD OF THE INVENTION

This description relates generally to social networks and to computer data and information systems accessed through social networks, and more precisely, this invention pertains to a method and system for customizing relationships between members of a social network based on a multi-facet profile.

### BACKGROUND OF THE INVENTION

Computer mediated social interaction and networking was suggested early on. There were many early efforts to support social networks via computer-mediated communication.

Early social networking websites were launched in the mid-90s. Some were focusing on ties with former school mates, while others were focusing on indirect ties. User profiles could be created, messages sent to users held on a “friends list” and other members could be sought out who had similar interests to yours in their profiles.

By the end of the 90s, trust-based and friendship-based concepts of social networking emerged. Innovations included not only showing who is “friends” with whom, but giving users more control over content and connectivity.

Between 2002 and 2004, social networking sites became part of mainstream users worldwide. Major players included Friendster, MySpace, Bebo, and Facebook. Facebook is today the most popular social network, and claims over 200 million registered users worldwide.

Various social networking sites have sprung up catering to different languages and countries. It is estimated that combined there are now over 200 social networking sites using these existing and emerging social networking models, without counting the niche social networks (also referred to as vertical social networks) made possible by services such as Ning.

Social networks have always been criticized for being too loose with the information provided by the members. The wealth of this information attracts profilers from various industries.

It has become increasingly common for colleges and universities to use Facebook to investigate violations of campus policies. Students who violate these policies may be discovered through photographs of illicit behavior, membership in groups, or simply information posted on the Facebook website.

Students, angered by the monitoring, have begun to submit “red herring” party listings

In addition, 10 percent of admissions officers from prestigious schools said they had peeked at sites like Facebook and MySpace to evaluate college-bound seniors. Of those using the profiles, 38 percent said it had a “negative impact” on the applicant, according to Kaplan Inc., the education services company that polled the officers.

Employers are increasingly scouring the Internet for “digital dirt” to help them weed through job candidates. In fact, 83.2 percent of recruiters admitted to using online search engines in 2007 to uncover information about candidates, according to Execunet. Of these recruiters, 43 percent admitted to eliminating candidates based on the negative information they found.

As the number of job seekers continues to increase and the pressure to reduce costs continues, companies seek alternatives to paid background checks leading to the appearance of sites specializing in “social reference checks” that will make a background check on an employee through social networks.

Official organizations do try to prevent users that once online their information is extremely hard to remove. These privacy issues are becoming so large that a new business model was born: Reputation Guardians. Companies such as ReputationDefender target teenagers' parents by offering monitoring services of their children social behavior.

Even CNN pushed a story on office/facebook relationships in January 2009 advising that “you should be monitoring your online content as though your current and future boss can see it, even if they aren't on your buddy list.”

Current social networks are basing their revenue stream on advertising and data sharing. Both models imply the spreading of information that could be considered private.

Patents are even being filed that shows methods of identifying the influential elements within social networks in order to push targeted ads. The first of the pack is Google with its profiling capabilities over a vast amount of sites.

Every day more resources become available to the social network users to warn them about the privacy problems they can encounter if they are not careful about their personal information.

In 2009, in an effort to increase awareness of the online privacy issues, the US House of Representatives, following the European Council, has approved Bill H. RES.31 declaring January 28th, a National Data Privacy Day.

With all these facts, it is hard to believe that social network users are not aware of the potential consequences of their actions. A Rubicon survey, however, still shows that a high number of users would feel embarrassed if part of their profile would become known to some people.

Another study claims that: 43% of adults think it would be pretty easy for someone to find out who they are from their profile; 23% of teens say it would be pretty easy; 33% of adults with profiles think that they would have to work at it, but that someone could eventually find out who they are; 40% of teens say the same; 20% of adults think that it would be difficult for someone to find out who they are; 36% of teens say it would be difficult for someone to find out who they are.

It is clear from these numbers that the perception of privacy differs as one grows older. Furthermore, it strongly suggests that all the industry warnings do not reach the target audience.

Even if they learned about the risks, their options are often limited to the poor and complex settings offered by their favorite sites. The other alternative is to create additional profiles on these networks.

24% of users that have multiple social network accounts do so to either separate their personal from their professional life or to represent a different aspect of their personality.

These users are sharing information because they do not have easy access to preemptive information on social networks, and do not possess the tools that would give them the benefits of sharing with the privacy and the security to protect their future.

On the surface, social network users advance that their primary reason of using such tool is to keep in touch with their close friends. However, when one looks at the deeper significance of social networks one realizes that social networks are a crucial element to help anyone trying to define himself and to gain self-confidence.

It is important to understand that a user will always organize his social environment by priority. Below is an example of such perceived audience from the closest relationships to the furthest.

Each social user attributes an importance to the feedback he obtains from each of these groups. Hence, a positive feedback from a friend will be significantly more self-fulfilling than one from a professor.

It is important for the user to receive feedback concerning the elements that define him. Social sites typically focus on such aspects.

When looking at the various elements that define today's youth, we realize that materialist behavior is not only important but also growing. Surprisingly enough, social networks have always steered away from using social objects for identity purposes trying instead to use them for shopping activities. According to a warning given to the Annual Meeting of the Royal College of Psychiatrists (U.K.), reported by Snugd, the Facebook Generation who use internet for everything and who have never known a world unless they surf on-line are growing up with a dangerous view of the world and their own identity. They are going through major identity crisis. People who born after 1990 have grown up in a world dominated by online social networks such as Facebook and MySpace.

Many of these youngsters use Internet as the main medium to communicate. Their relationships are quickly disposed at the click of a mouse. Because of the online social networking, people find the real world boring and unstimulating. These interactions between people in the digital realm reduced sensory experience; person's expression/body language/voice/tone aren't there; and this can shape one's perceptions of such an interaction differently.

Online session changes the perception to a [unreal, fantastic, imagery] dreamlike state, and this unnatural blending of mind with the other person leads to entirely different meaning to friendships and relationships. Because of this online mess, youngsters are going through the stages of vulnerable to impulsive to suicide.

The lack of feedback for material possessions in social networks creates an important void in the road for stronger self-esteem. Without that relation placed in the context of each perceived audience, a social user can never feel as complete online as in real life.

When considering the above issues one should realize that they are normally inexistent in the real world. In fact, privacy, image management and material interactions are present in our everyday life that they are often taken for granted.

Without the natural rules of social interactions, technology will use online relationships for capital gain at the detriment of the interlocutors.

### SUMMARY OF THE INVENTION

It is therefore an object of the present invention to provide methods and systems that overcome the above drawbacks.

As a first aspect of the present invention, there is provided a method for customizing a relationship between members of a social network based on a multi-facet member profile, the method comprising:

receiving profile data associated with a member;

segregating at least a part of the profile data into a plurality of identifiable profile facets, and storing data records associated therewith in a multi-facet profile database;

receiving from the member relationship parameters comprising: an identification of at least one other member of the social network, an identification of at least one profile facet among the identifiable profile facets, and sharing parameters defining access privileges to the at least one profile facet by the at least one other member; and

based on the relationship parameters, storing in a relationship database data records allowing for determining, for each one of the at least one other member, access privileges associated with each one of the at least one profile facet.

The method preferably further comprises:

inquiring the relationship database for determining if a given member of the social network is allowed to access a given profile facet among the plurality of profile facets; and

as a function of the inquiring, declining or allowing access to the given profile facet by the given member.

Preferably, the identifiable profile facets comprise at least one intrinsic profile facet and at least one extrinsic profile facet, where each one of the at least one extrinsic profile facet discloses a relation of the member with an element of his environment.

Preferably, the element is selected from the group consisting of a material item, an animal, a person, a place, an event, and a group of interest.

Preferably, the relationship parameters further comprise an identification of at least one interactional medium among a plurality of interactional mediums provided for use over the social data network, and use restriction parameters in connection with the at least one interactional medium and the at least one other member, and the method further comprises: based on the relationship parameters, storing in the relationship database data records allowing for determining, for each one of the at least one other member, use privileges associated with each one of the at least one interactional medium in order to interact with the member or the member's contacts.

Preferably, the method further comprises:

inquiring the relationship database for determining if a given member of the social network is allowed to use a given interactional medium among the plurality of interactional mediums to interact with the member or the member's contacts;

as a function of the inquiring, enabling or disabling the given member to interact with the member using the given interactional medium.

Preferably, the plurality of interactional mediums comprise at least one of text chatting, email messaging, voice conferencing, and video-conferencing.

Preferably, the relationship parameters further comprise an identification of contacts of the member over the social network and visibility parameters in connection with the at least one other member and the member's contacts, and the method further comprises:

based on the relationship parameters, storing in the relationship database data records allowing for determining, for each one of the at least one other member, visibility privileges associated with each one of the member's contacts.

Preferably, the method further comprises:

inquiring the relationship database for determining if a given member of the social network is allowed to have a visibility of a given contact among the member's contacts; and

as a function of the inquiring, declining or allowing visibility of the given member's contact to the given member.

Preferably, the relationship parameters further comprise an indication if system-generated alerts associated with the member are allowed or restricted to be transmitted to the at least one other member, and the method preferably further comprises:

based on the relationship parameters, storing in the relationship database data records allowing for determining, for each one of the at least one other member, transmitted alert privileges associated with the member.

Preferably, the method further comprises:

inquiring the relationship database for determining if a given system-generated alert associated with the member is allowed to be transmitted to a given member of the social network; and

as a function of the inquiring, declining or allowing transmission of the given system-generated alert to the given member.

Preferably, the relationship parameters further comprise an indication if system-generated alerts transmitted thereto and associated with the at least one other member are allowed or restricted, and the method preferably further comprises:

based on the relationship parameters, storing in the relationship database data records allowing for determining received alert privileges associated with each one of the at least one other member.

Preferably, the method further comprises:

inquiring the relationship database for determining if a given system-generated alert originating from a given member of the social network is allowed to be received by the member; and

as a function of the inquiring, declining or allowing reception of the given system-generated alert by the member.

Preferably, the segregating at least a part of the profile data into a plurality of identifiable profile facets comprises:

associating with each one of the profile facets a correspondent degree of intimacy, and storing data records associated therewith in the multi-facet profile database.

Preferably, the receiving from the member an identification of at least one profile facet among the identifiable profile facets comprises:

enabling the member to hierarchically identify the at least one profile facet by providing at least one of an indication of a given degree of intimacy and an identification of a given profile facet associated with the given degree of intimacy, where the at least one profile facet is deemed to include all profile facets associated with a degree of intimacy lower or equal to the given degree of intimacy among the plurality of profile facets.

The segregation process can be carried out by the member.

The segregation process can be also carried out automatically as a function of segregation criteria defined by the member.

As a further aspect of the present invention, there is provided a system for customizing a relationship between members of a social network based on a multi-facet member profile, the system comprising:

a multi-facet profile generator for receiving profile data associated with a member, and for segregating at least a part of the profile data into a plurality of identifiable profile facets, where the multi-facet profile generator is adapted to be connected to a multi-facet profile database for storing therein data records associated with the plurality of identifiable profile facets;

a relationship parameters receiving module for receiving relationship parameters comprising: an identification of at least one other member of the social network, an identification of at least one profile facet among the identifiable profile facets, and sharing parameters defining access privileges to the at least one profile facet by the at least one other member; and

a relationship customizing module adapted to be connected to the relationship parameters receiving module for generating, as a function of the relationship parameters, relationship data records comprising data records allowing for determining, for each one of the at least one other member, access privileges associated with each one of the at least one profile facet, where the relationship customizing module is adapted to be connected to a relationship database for storing therein the generated data records.

Preferably, the segregating at least a part of the profile data into a plurality of identifiable profile facets comprises associating with each one of the profile facets a correspondent degree of intimacy, and storing data records associated therewith in the multi-facet profile database.

Preferably, the relationship parameters receiving module is adapted to be connected to the multi-facet profile database for enabling the member to hierarchically identify the at least one profile facet by providing at least one of an indication of a given degree of intimacy and an identification of a given profile facet associated with the given degree of intimacy, where the at least one profile facet is deemed to include all profile facets associated with a degree of intimacy lower or equal to the given degree of intimacy among the plurality of profile facets.

Preferably, the relationship parameters further comprise an identification of at least one interactional medium among a plurality of interactional mediums provided for use over a social data network, and use restriction parameters in connection with the at least one interactional medium and the at least one other member, wherein the generated relationship data records further comprise data records allowing for determining, for each one of the at least one other member, use privileges associated with each one of the at least one interactional medium in order to interact with the member or the member's contacts.

Preferably, the relationship parameters further comprise an identification of contacts of the member over a social network and visibility parameters in connection with the at least one other member and the member's contacts, wherein the generated relationship data records further comprise data records allowing for determining, for each one of the at least one other member, visibility privileges associated with each one of the member's contacts.

Preferably, the relationship parameters further comprise an indication if system-generated alerts associated with the member are allowed or restricted to be transmitted to the at least one other member, wherein the generated relationship data records further comprise data records allowing for determining, for each one of the at least one other member, transmitted alert privileges associated with the member.

Preferably, the relationship parameters further comprise an indication if system-generated alerts transmitted thereto and associated with the at least one other member are allowed or restricted, wherein the generated relationship data records further comprise data records allowing for determining received alert privileges associated with each one of the at least one other member.

As a further aspect of the invention, there is provided a system for managing sharing of information over a social network, the system comprising:

a relationship database comprising data records comprising data records allowing for determining, for each one of at least one profile facet among a plurality of profile facets of a first member, access privileges associated with each one of at least one other member;

an inquiring module adapted to be connected to the relationship database; and

a multi-facet profile access securing module adapted to be connected to the social network, to the inquiring module and to a multi-facet profile database comprising the plurality of profile facets of the first member, where the multi-facet profile access securing module receives a request originating from the social network to access a given profile facet among the plurality of profile facets by a given member, generates and transmits an inquiring request to the inquiring module for inquiring if the given member is allowed to access the given profile facet, receives an inquiring response thereof, and if required, maps the given member to the given profile facet stored in the multi-facet profile database.

Preferably, the data records stored in the relationship database further comprise data records allowing for determining, for each one of the at least one other member, use privileges associated with each one of at least one interactional medium among a plurality of interactional mediums provided for use over the social data network, and the system preferably further comprises:

an interactional medium enabling module adapted to be connected to the social network, to the inquiring module and to the plurality of interactional mediums, where the interactional medium enabling module receives a request originating from the social network to enable a given member to interact with the member using a given interactional medium among the plurality of interactional mediums, generates and transmits an inquiring request to the inquiring module for inquiring if the given member is allowed to interact with the member using the given interactional medium, receives an inquiring response thereof, and if required, maps the given member to the given interactional medium.

Preferably, the data records stored in the relationship database further comprise data records allowing for determining, for each one of the at least one other member, visibility privileges associated with each one of contacts of the member, and the system preferably further comprises:

a member's contacts visibility securing module adapted to be connected to the social network, to the inquiring module and to a database storing profile data associated with contacts of the member, where the member's contacts visibility securing module receives a request originating from the social network to enable a given member to have a visibility of a given contact among the member's contacts, generates and transmits an inquiring request to the inquiring module for inquiring if the given member is allowed to have a visibility of the given contact, and if required, maps the given member to the given contact.

Preferably, the data records stored in the relationship database further comprise data records allowing for determining, for each one of the at least one other member, transmitted alert privileges associated with the member, and the system preferably further comprises:

a transmitted alerts controlling module adapted to be connected to the social network, to the inquiring module and to a transmitted alerts database, where the transmitted alerts controlling module receives a request originating from the social network to transmit a given system-generated alert associated with the member to a given member of the social network, generates and transmits an inquiring request to the inquiring module for inquiring if the given system-generated alert is allowed to be transmitted to the given member, receives an inquiring response thereof, and if required, allows transmission of the given system-generated alert to the given member.

Preferably, the data records stored in the relationship database further comprise data records allowing for determining received alert privileges associated with each one of the at least one other member, and the system preferably further comprises:

a received alerts controlling module adapted to be connected to the social network, to the inquiring module and to a received alerts database, where the received alerts controlling module receives a request originating from the social network to allow reception of a given system-generated alert originating from a given member of the social network by the member, generates and transmits an inquiring request to the inquiring module for inquiring if the given system-generated alert originating from the given member is allowed to be received by the member, and if required, allows reception of the given system-generated alert by the member.

### BRIEF DESCRIPTION OF THE DRAWINGS

Further features and advantages of the present invention will become apparent from the following detailed description, taken in combination with the appended drawings, in which:

FIG. 1 is a bloc diagram which shows an embodiment of a system for customizing a relationship between members of a social network based on a multi-facet member profile;

FIG. 2 is a bloc diagram which shows an embodiment of a system for managing sharing of information over a social network;

FIG. 3 is a flowchart which shows a first embodiment of a method for customizing a relationship between members of a social network based on a multi-facet member profile;

FIG. 4 is a flowchart which shows a second embodiment of a method for customizing a relationship between members of a social network based on a multi-facet member profile;

FIG. 5 is a flowchart which shows a third embodiment of a method for customizing a relationship between members of a social network based on a multi-facet member profile;

FIG. 6 is a flowchart which shows a fourth embodiment of a method for customizing a relationship between members of a social network based on a multi-facet member profile; and

FIG. 7 is a flowchart which shows a fifth embodiment of method for customizing a relationship between members of a social network based on a multi-facet member profile;

FIG. 8 is a flowchart which shows a sixth embodiment of method for customizing a relationship between members of a social network based on a multi-facet member profile;

FIG. 9 illustrates a relationship framework in accordance with one embodiment of the present invention;

FIG. 10 is an example of relationship customization in accordance with one embodiment of the present invention;

It will be noted that throughout the appended drawings, like features are identified by like reference numerals.

### DESCRIPTION OF THE PREFERRED EMBODIMENTS

Solutions provided by the present invention:

The present invention provides solutions for users that concern themselves with how they look online, who looks at them and that want to receive feedback for the relations they establish with various material items of their environment.

Advanced Social Network Functionalities:

When developing the present invention, a unique relationship framework has been created, which includes the user's identity and its various relationship types.

A—The User Identity

The identity is the core element of any social network. It defines the user. Using his identity, he creates relationships and request feedbacks that will help improve his image. The present invention's uniqueness consists primarily of the following:

Material Relations

There is a need for one to express himself through his relations with material items and provide an environment that will allow the user to describe these relations over a period time. In addition, using a product database, one can make list of items based on his preferences.

The benefit of using such a system is to be flexible enough to allow a user to identify himself through music or movies.

Implication

To be successful, the present technology using community requires a commitment from its members. From entering product information to uploading photos and videos, users participate in creating the generic value of the community. Such implication is rewarded as part of their identity.

B—User Relationships

Users behave differently depending with who they develop a relationship. As such, the present invention provides an environment that can support a wide variety of relationship types. Additionally, the present invention provides tools for users to customize their profile based on the relationship type.

Relationship Types

Users have various degrees of relationship in real life and the present invention is dedicated to represent them in its community.

The present invention tailors the user experience based on these relationships. They are: Friends, Groups, Fans & Favorites, Public Profile.

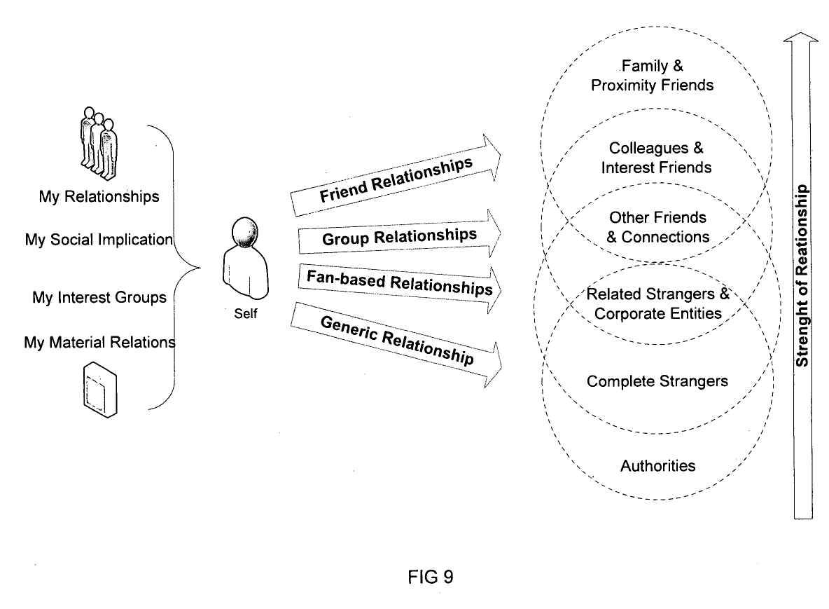

The uniqueness of the present invention is its ability in using these relationships to reflect real life interactions within the virtual world. Each type is associated to a feature set that appropriately defines it (see FIG. 9).

Relationship Customization:

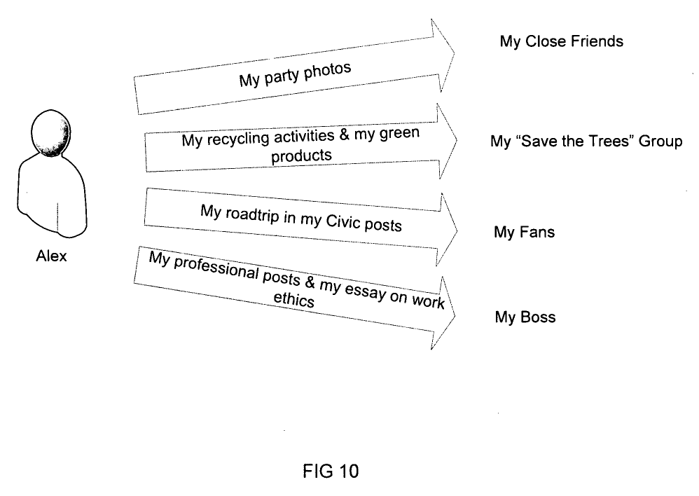

Not content with the variety of relationship type, the present invention provides the user with the necessary tools to model each relationship based on his real life interaction. Basically, the element of his profile and the activities on the platform are shared based on the user's preferences. FIG. 10 illustrates an example of the reality of a user named Alex's translated in accordance with the present invention.

Corporate Relations:

For many members of our society, companies can participate in a value added relationship. Should the corporate entity have a proper social marketing plan, the present invention provides them with the necessary tools to establish contact and to nurture a social commitment from the social network member.

The present invention uses a front-door policy for this type of relationships integrating concept of permission marketing within the Fans/Followers relationship type. Tools such as crowdsourcing and demoing will be available.

Subscription-Based Services:

If the social network features developed respond to most members, there are services that will satisfy only a small percentage of the that are developed as well. Some of these services are:

StrongBox:

The StrongBox is an encrypted area of a users' profile where he can put data for non-sharing purposes. This data could be: Photos, Files, Product serial numbers & valuation for insurance purposes, Product purchase date & location.

Any content in a StrongBox is private, has a specific privacy agreement, is not counted toward user-created content in our statistics. This service tends to the need of having really private information completing the online environment of the user.

Collections:

The Collections features allow a member to manipulate several products at the same time and to create checklists. It also allows him to add information to lists in order to present and manage his collections of items.

These collections are part of the identity of a user as he most likely spent several hours to build it. However, to upload it is tiresome and having these additional features will motivate him to do so.

For Sale Inventory:

The For Sale features enable the member to add commercial information to the products in his profile. For example, if a student wants to sell some used school books, he could use the For Sale feature to sell them in one click.

In General:

In developing the above mentioned functionalities, the present invention allows for moving forward to replicate in online communities, the real social behavior of Internet users. Future developments will also aim to recreate the ease and the natural aspects of these interactions.

System Description:

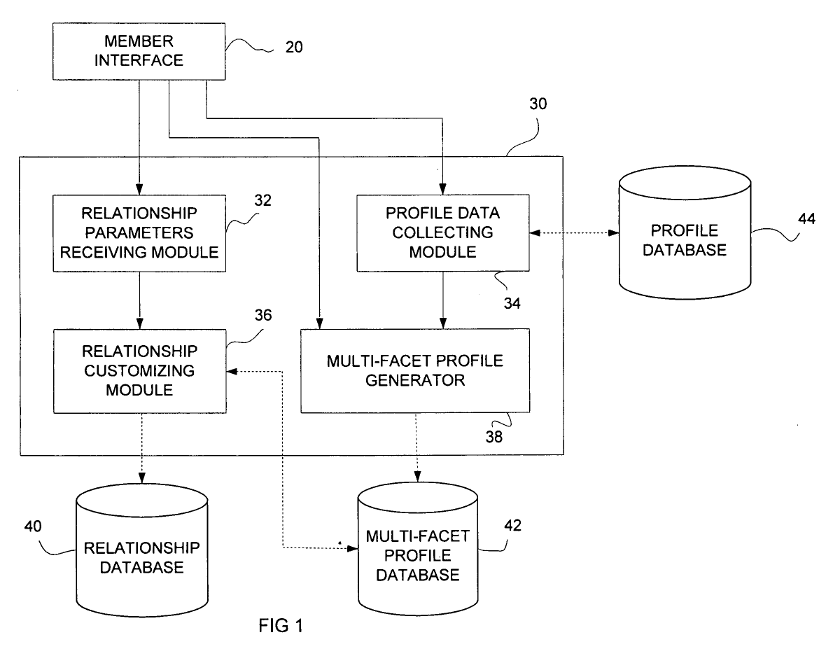

Referring to FIG. 1, there is provided a system for customizing a relationship between members of a social network based on a multi-facet member profile 30. The system comprises a relationship parameters receiving module 32, a profile data collecting module 34, a relationship customizing module 36 and a multi-facet profile generator 38.

The profile data collecting module 30 is adapted for receiving profile data associated with a first member of the social network. A person skilled in the art should understand that the profile data collecting module 30 can be connected locally or remotely via a data network to any device, interface or database allowing for providing the profile data, such as a member interface 20 or a profile database 44.

The profile data can be manually provided by the member, via the member interface 20 for example, or automatically collected from a local or remote database or device.

The profile data collecting module 30 is connected to the multi-facet profile generator 38 for transmitting thereto the collected profile data.

The multi-facet profile generator 38 receives the collected profile data associated with the first member and segregates at least a part of the profile data into a plurality of identifiable profile facets. The segregation process can be carried out manually by the first member using the member interface 20 for example, or automatically according to defined segregation criteria. The segregation criteria can be defined by the member via the member interface 20 for example, or predefined and stored in storage means connected to the multi-facet profile generator 38.

The social reality of a person is reflected by the intrinsic profile of the person as well as by his interactions with the elements of his environment. Generally, each segregated profile facet reflects a distinct aspect of the member profile that is preferably represented by a booklet.

The profile facets are divided into intrinsic profile facets and extrinsic profile facets. The intrinsic profile facets generally comprise static information about the member, information that is related to his own person, such name, address, age, profession, horoscope, gender, physical appearance, marital status, etc.

Regarding the extrinsic profile facets, each one discloses a relation of the member with an element of his environment, such as a material item, an animal, a person, a place, an event, or a group of interest.

The segregated profile facets can be organized according to various logical graphs. According to one embodiment of the invention, the facets are logically organised in a hierarchical manner, where each hierarchical profile facet is associated with a degree of intimacy, with the most personal profile on the top of the pile (highest degree of intimacy) and the less personal at the bottom (lower degree of intimacy).

A hierarchical organization of profile facets enables for interesting methods of managing the profile facets and securing intimacy violation of members over a social networks. For example, in a hierarchy organized profile facets, it can be defined that peers in an upper profile can have knowledge of the reality represented in the lower facet, but not the opposite.

According to this embodiment of the invention, by using the member interface 20, the member associates with each one of the profile facets a correspondent degree of intimacy.

The multi-facet profile generator 38 is adapted to be connected to a multi-facet profile database for storing therein data records associated with the plurality of identifiable profile facets and with the correspondent associated degrees of intimacy if it is the case.

The relationship parameters receiving module 32 is adapted for receiving relationship parameters comprising: an identification of at least one other member of the social network, an identification of at least one profile facet among the identifiable profile facets, and sharing parameters defining access privileges to the at least one profile facet by the at least one other member.

A person skilled in the art should understand that the relationship parameters receiving module 32 can be connected locally or remotely (via a data network) to any device, application, interface or database allowing for providing the relationship parameters, such as a member interface 20 or a Web-based application allowing for selecting the at least one profile facet or the at least one other member from a list.

In one embodiment of the present invention, the relationship parameters receiving module 32 allows said member to hierarchically identify the at least one profile facet by providing at least one of an indication of a given degree of intimacy and an identification of a given profile facet associated with the given degree of intimacy, where the at least one profile facet is deemed to include all profile facets associated with a degree of intimacy lower or equal to the given degree of intimacy among the plurality of profile facets.

The relationship customizing module 36 is connected to the relationship parameters receiving module 32 for receiving the relationship parameters and for generating, as a function of the relationship parameters, relationship data records comprising data records allowing for determining, for each one of said at least one other member, access privileges associated with each one of the at least one profile facet. The relationship customizing module 36 is adapted to be connected to a relationship database 40 for storing therein the generated data records.

A person skilled in the art should understand that the relationship customizing module 36 can be connected locally or remotely (via a data network) to the relationship database 40.

According to another embodiment of the present invention, the relationship parameters further comprise an identification of at least one interactional medium among a plurality of interactional mediums provided for use over a social data network, and use restriction parameters defining, for each one of the at least one other member, which medium he is allowed to use to interact with the first member or the first member's contacts.

The interactional mediums provided over the social network generally comprise text chatting, SMS messaging, email messaging, voice conferencing, and video-conferencing.

As an example of such an application, the first member can decide to allow a second member to interact with him using all of the available interactional mediums due to his high level of personal relation therewith, but to limit a third member to use only email messaging to interact with him due to his impersonal relation therewith.

In this case, the relationship customizing module 36 further generates data records allowing for determining, for each one of the at least one other member, use privileges associated with each one of the at least one interactional medium in order to interact with the first member or his contacts.

According to a further embodiment of the present invention, the relationship parameters further comprise an identification of the first member's contacts over the social network and visibility parameters to be set between them and the at least one other member.

In other terms, while customizing his relation with a second member, the first member can decide who among his other contacts will be visualized by the second member.

In this case, the relationship customizing module 36 further generates data records allowing for determining, for each one of the at least one other member, visibility privileges associated with each one of the member's contacts.

According to another embodiment of the present invention, the relationship parameters further comprise an indication if system-generated alerts associated with the first member are allowed or restricted to be transmitted to the at least one other member.

In this case, the relationship customizing module 36 further generates data records allowing for determining, for each one of the at least one other member, transmitted alert privileges associated with the first member.

According to a further embodiment of the present invention, the relationship parameters further comprise an indication if system-generated alerts transmitted thereto and associated with the at least one other member are allowed or restricted.

This embodiment of the invention is to allow the first member to filter the received alerts from the other members of the social network.

In this case, the relationship customizing module 36 further generates data records allowing for determining received alert privileges associated with each one of the at least one other member.

When all these embodiments of the invention are implemented in the same system, the relationship database 40 would comprise:

A) data records allowing for determining, for each one of the at least one other member, access privileges associated with each one of the at least one profile facet;

B) data records allowing for determining, for each one of the at least one other member, use privileges associated with each one of the at least one interactional medium in order to interact with the first member or his contacts;

C) data records allowing for determining, for each one of the at least one other member, visibility privileges associated with each one of the first member's contacts;

D) data records allowing for determining, for each one of the at least one other member, transmitted alert privileges associated with the first member;

E) data records allowing for determining received alert privileges associated with each one of the at least one other member;

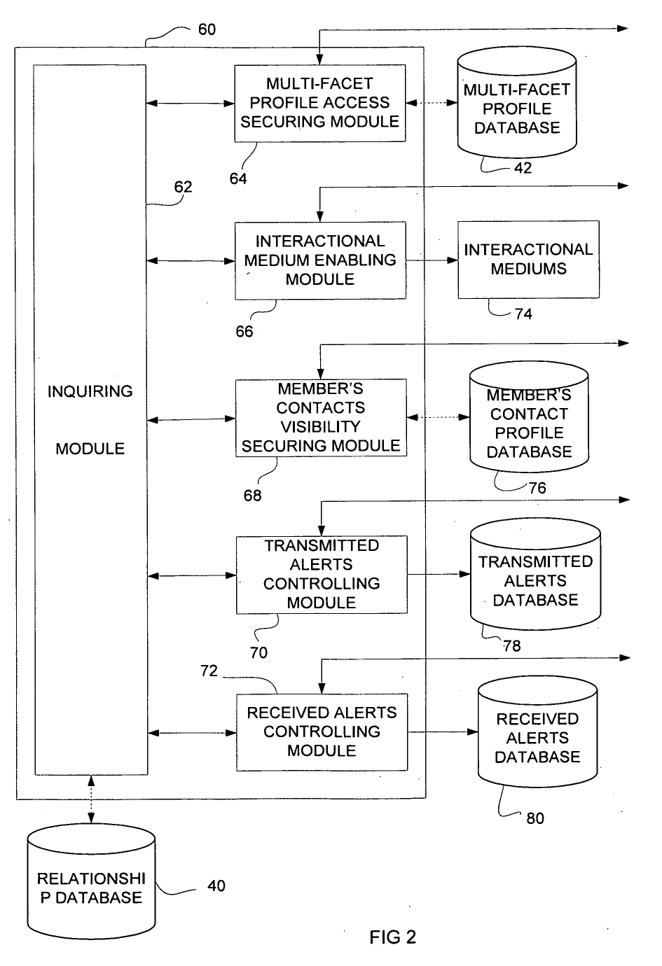

Referring to FIG. 2, there is provided a system for managing sharing of information over a social network 60, the system comprising a relationship database 40, an inquiring module 62, a multi-facet profile access securing module 64, an interactional medium enabling module 66, a member's contacts visibility securing module 68, a transmitted alerts controlling module 70 and a received alerts controlling module 72.

The relationship database 40 comprises data records as described hereinabove.

The inquiring module 62 is adapted to be connected to the relationship database 40. The inquiring module 62 receives an inquiring request from a given source module, inquires the relationship database 40 as a function of parameters embedded in the received request, by generating and transmitting to the relationship database 40 an inquiry compatible with the relationship database language (ex. SQL, etc.), receives inquiry results thereof, and generates and transmits an inquiring response to the source module.

The source module can be any of the multi-facet profile access securing module 64, the interactional medium enabling module 66, the member's contacts visibility securing module 68, the transmitted alerts controlling module 70 and the received alerts controlling module 72.

The multi-facet profile access securing module 64 is connected to the social network, to the inquiring module 62 and to the multi-facet profile database 42 comprising the plurality of profile facets of the first member. The multi-facet profile access securing module 64 receives a request originating from the social network to access a given profile facet among the plurality of profile facets by a given member, generates and transmits an inquiring request to the inquiring module 62 for inquiring if the given member is allowed to access the given profile facet, receives an inquiring response thereof, and if the inquiring response is positive, maps the given member to the given profile facet stored in the multi-facet profile database 42.

A person skilled in the art should understand that the multi-facet profile access securing module 64 can be connected locally or remotely (via a data network) to the multi-facet profile database.42.

The interactional medium enabling module 66 is connected to the social network, to the inquiring module 62 and to the plurality of interactional mediums 74. The interactional medium enabling module 66 receives a request originating from the social network to enable a given member to interact with the first member using a given interactional medium among the plurality of interactional mediums, generates and transmits an inquiring request to the inquiring module 62 for inquiring if the given member is allowed to interact with said member using said given interactional medium, receives an inquiring response thereof, and if required, maps the given member to the given interactional medium.

A person skilled in the art should understand that the interactional medium enabling module 66 can be connected locally or remotely (via a data network) to the plurality of interactional mediums 74.

The member's contacts visibility securing module 68 is connected to the social network, to the inquiring module 62 and to a member's contact profile database 76 storing profile data associated with contacts of the first member. The member's contacts visibility securing module 68 receives a request originating from the social network to enable a given member to have a visibility of a given contact among the member's contacts, generates and transmits an inquiring request to the inquiring module 62 for inquiring if the given member is allowed to have a visibility of the given contact, and if inquiring response is positive, maps the given member to the given contact.

A person skilled in the art should understand that the member's contacts visibility securing module 68 can be connected locally or remotely (via a data network) to the member's contact profile database 76.

The transmitted alerts controlling module 70 is connected to the social network, to the inquiring module 62 and to a transmitted alerts database 78. The transmitted alerts controlling module 70 receives a request originating from the social network to transmit a given system-generated alert associated with the first member to a given member of the social network, generates and transmits an inquiring request to the inquiring module 62 for inquiring if the given system-generated alert is allowed to be transmitted to the given member, receives an inquiring response thereof, and if the inquiring response is positive, allows transmission of the given system-generated alert to the given member.

A person skilled in the art should understand that the transmitted alerts controlling module 70 can be connected locally or remotely (via a data network) to the transmitted alerts database 78.

The received alerts controlling module 72 is connected to the social network, to the inquiring module 62 and to the received alerts database 80. The received alerts controlling module 72 receives a request originating from the social network to allow reception of a given system-generated alert originating from a given member of the social network by the first member, generates and transmits an inquiring request to the inquiring module 62 for inquiring if the given system-generated alert originating from the given member is allowed to be received by the first member, and if the inquiring response is positive, allows reception of the given system-generated alert by the member.

A person skilled in the art should understand that the received alerts controlling module 72 can be connected locally or remotely (via a data network) to the received alerts database 80.

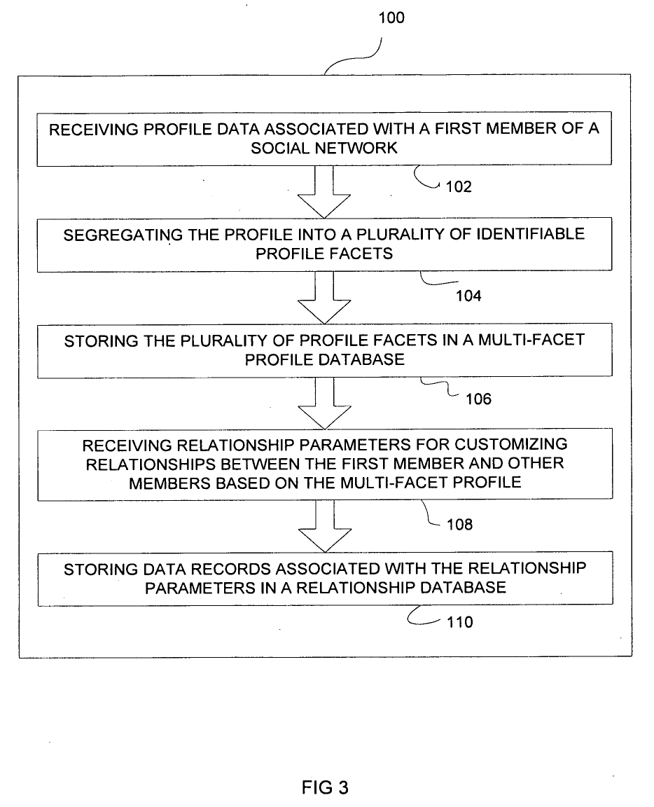

Referring to FIG. 3, there is provided a first embodiment of a method for customizing a relationship between members of a social network based on a multi-facet member profile 100.

The first step consists of receiving profile data associated with a first member of the social network 102. As mentioned hereinabove, a person skilled in the art should understand that the profile data can be collected (locally or remotely via a data network) from any device, application, interface or database allowing for providing the profile data, such as a member interface 20 or a profile database 44. The profile data can be manually provided by the member, via the member interface 20 for example, or automatically collected from a local or remote database or device.

The second step of this method consists of segregating at least a part of the profile data into a plurality of identifiable profile facets 104. The mechanism of the segregation process is detailed hereinabove.

The third step of this method consists of storing data records associated with the plurality of identifiable profile facets in a multi-facet profile database 106.

The fourth step consists of receiving from the first member relationship parameters comprising: an identification of at least one other member of the social network, an identification of at least one profile facet among the identifiable profile facets, and sharing parameters defining access privileges to the at least one profile facet by the at least one other member 108.

As mentioned hereinabove, a person skilled in the art should understand that the relationship parameters can be collected (locally or remotely via a data network) from any device, application, interface or database allowing for providing the relationship parameters, such as a member interface 20 or a Web-based application allowing for selecting the at least one profile facet or the at least one other member from a list.

The fifth step consists of storing in a relationship database 40, based on the relationship parameters, data records allowing for determining, for each one of the at least one other member, access privileges associated with each one of the at least one profile facet 110.

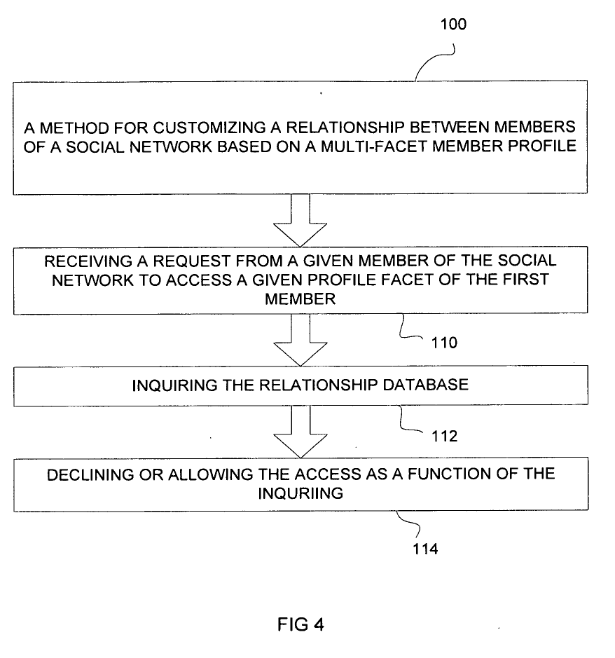

Referring to FIG. 4, there is provided a second embodiment of a method for customizing a relationship between members of a social network based on a multi-facet member profile 100.

Once the relationship database 40 based on multi-profiling is built, the next step consists of receiving a request from a given member of the social network to access a given profile facet of the first member 110. Generally, the request comprises information allowing for determining an identity of the given member and the given profile facet he wishes to access.

Once the request is received, the further step consists of inquiring the relationship database 40 for determining if the given member is allowed to access the given profile facet among said plurality of profile facets 112.

And finally, as a function of the inquiring results, the last step according to this second embodiment consists of declining or allowing access to the given profile facet by the given member 114.

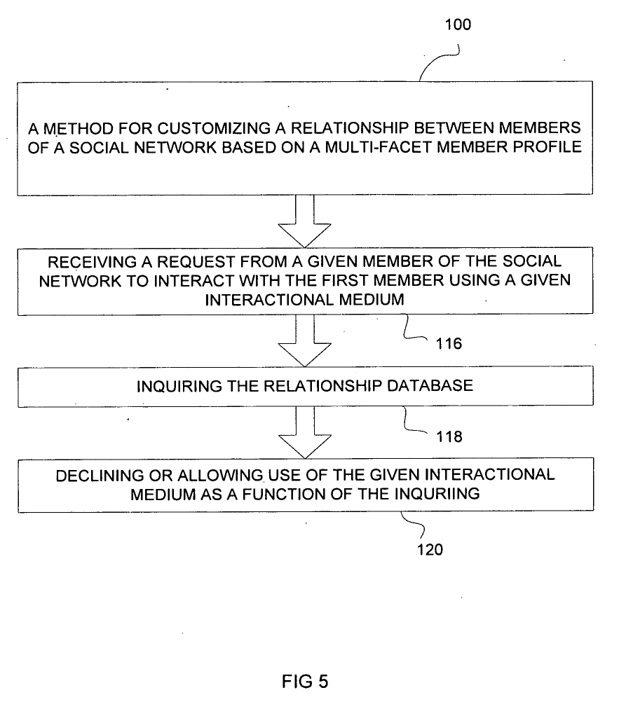

Referring to FIG. 5, there is provided a third embodiment of a method for customizing a relationship between members of a social network based on a multi-facet member profile 100.

According to this third embodiment, after building the relationship database 40, the first step consists of receiving a request from a given member of the social network to interact with the first member using a given interactional medium among the plurality of interactional mediums provided over the social network 116.

The second step consists of inquiring the relationship database for determining if the given member of the social network is allowed to use the given interactional medium to interact with the first member or the first member's contacts 118.

The third step consists of, as a function of the inquiring results, enabling or disabling the given member to interact with the first member using the given interactional medium 120.

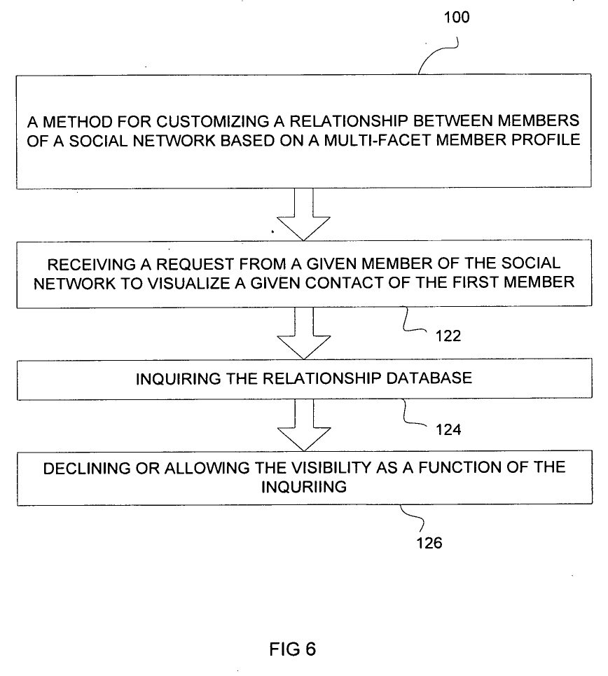

Referring to FIG. 6, there is provided a fourth embodiment of a method for customizing a relationship between members of a social network based on a multi-facet member profile 100.

According to this fourth embodiment, after building the relationship database 40, the first step consists of receiving a request from a given member of the social network to visualize a given contact of the first member 122.

The second step consists of inquiring the relationship database for determining if the given member of the social network is allowed to have a visibility of the given contact among said member's contacts 124.

The third step consists of, as a function of the inquiring results, declining or allowing visibility of the given member's contact to the given 126.

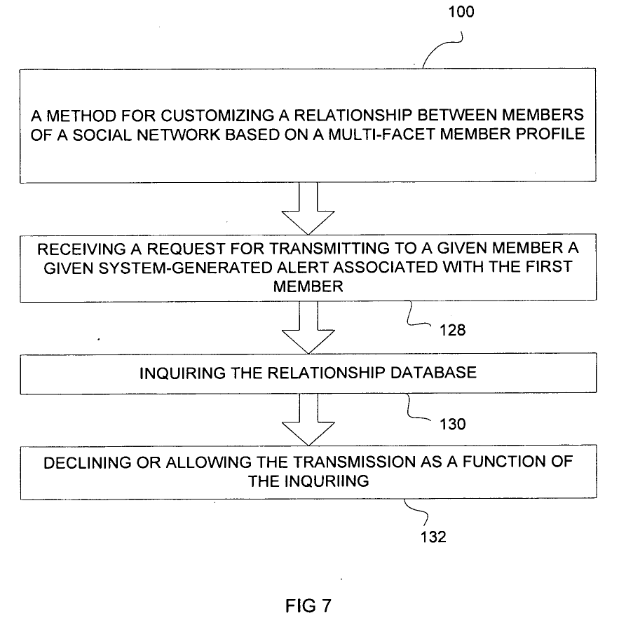

Referring to FIG. 7, there is provided a fifth embodiment of a method for customizing a relationship between members of a social network based on a multi-facet member profile 100.

According to this fifth embodiment, after building the relationship database 40, the first step consists of receiving a request for transmitting to a given member a given system-generated alert associated with the first member 128.

The second step consists of inquiring the relationship database for determining for determining if the given system-generated alert associated with the first member is allowed to be transmitted to the given member of the social network 130.

The third step consists of, as a function of the inquiring results, declining or allowing transmission of the given system-generated alert to the given member 132.

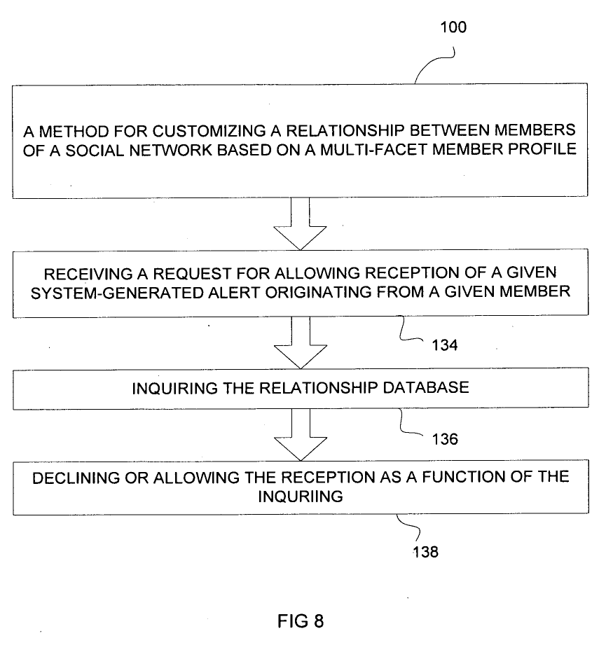

Referring to FIG. 8, there is provided a sixth embodiment of a method for customizing a relationship between members of a social network based on a multi-facet member profile 100.

According to this sixth embodiment, after building the relationship database 40, the first step consists of receiving a request for allowing reception of a given system-generated alert originating from a given member 134.

The second step consists of inquiring the relationship database for determining for determining if the given system-generated alert originating from the given member of the social network is allowed to be received by the first member 136.

The third step consists of, as a function of the inquiring results, declining or allowing reception of the given system-generated alert by the first member 138.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

The embodiment(s) of the invention described above is(are) intended to be exemplary only. The scope of the invention is therefore intended to be limited solely by the scope of the appended claims.

1. A method for customizing a relationship between members of a social network based on a multi-facet member profile, the method comprising:
receiving profile data associated with a first member;
segregating at least a part of said profile data into a plurality of identifiable profile facets, and storing data records associated therewith in a multi-facet profile database;
receiving from said first member relationship parameters comprising: an identification of at least one other member of said social network, an identification of at least one profile facet among said identifiable profile facets, and sharing parameters defining access privileges to said at least one profile facet by said at least one other member; and
based on said relationship parameters, storing in a relationship database data records allowing for determining, for each one of said at least one other member, access privileges associated with each one of said at least one profile facet.

2. The method as claimed in claim 1, further comprising:
inquiring said relationship database for determining if a given member of said social network is allowed to access a given profile facet among said plurality of profile facets; and
as a function of said inquiring, declining or allowing access to said given profile facet by said given member.

3. The method as claimed in claim 1, wherein said identifiable profile facets comprise at least one intrinsic profile facet and at least one extrinsic profile facet, where each one of said at least one extrinsic profile facet discloses a relation of said member with an element of his environment.

4. The method as claimed in claim 3, wherein said element is selected from the group consisting of a material item, an animal, a person, a place, an event, and a group of interest.

5. The method as claimed in claim 1, wherein said relationship parameters further comprise an identification of at least one interactional medium among a plurality of interactional mediums provided for use over said social data network, and use restriction parameters in connection with said at least one interactional medium and said at least one other member, said method further comprising:
based on said relationship parameters, storing in said relationship database data records allowing for determining, for each one of said at least one other member, use privileges associated with each one of said at least one interactional medium in order to interact with said first member or said first member's contacts.

6. The method as claimed in claim 5, further comprising:
inquiring said relationship database for determining if a given member of said social network is allowed to use a given interactional medium among said plurality of interactional mediums to interact with said first member or said first member's contacts; and
as a function of said inquiring, enabling or disabling said given member to interact with said first member using said given interactional medium.

7. The method as claimed in claim 5, wherein said plurality of interactional mediums comprise at least one of text chatting, email messaging, voice conferencing, and video-conferencing.

8. The method as claimed in claim 1, wherein said relationship parameters further comprise an identification of contacts of said first member over said social network and visibility parameters in connection with said at least one other member and said first member's contacts, said method further comprising:
based on said relationship parameters, storing in said relationship database data records allowing for determining, for each one of said at least one other member, visibility privileges associated with each one of said first member's contacts.

9. The method as claimed in claim 8, further comprising:
inquiring said relationship database for determining if a given member of said social network is allowed to have a visibility of a given contact among said first member's contacts; and
as a function of said inquiring, declining or allowing visibility of said given first member's contact to said given member.

10. The method as claimed in claim 1, wherein said relationship parameters further comprise an indication if system-generated alerts associated with said first member are allowed or restricted to be transmitted to said at least one other member, the method further comprising:
based on said relationship parameters, storing in said relationship database data records allowing for determining, for each one of said at least one other member, transmitted alert privileges associated with said first member.

11. The method as claimed in claim 10, further comprising:
inquiring said relationship database for determining if a given system-generated alert associated with said first member is allowed to be transmitted to a given member of said social network; and
as a function of said inquiring, declining or allowing transmission of said given system-generated alert to said given member.

12. The method as claimed in claim 1, wherein said relationship parameters further comprise an indication if system-generated alerts transmitted thereto and associated with said at least one other member are allowed or restricted, the method further comprising:
based on said relationship parameters, storing in said relationship database data records allowing for determining received alert privileges associated with each one of said at least one other member;

13. The method as claimed in claim 13, further comprising:
inquiring said relationship database for determining if a given system-generated alert originating from a given member of said social network is allowed to be received by said first member; and
as a function of said inquiring, declining or allowing reception of said given system-generated alert by said first member.

14. The method as claimed in claim 1, wherein said segregating at least a part of said profile data into a plurality of identifiable profile facets comprises:
associating with each one of said profile facets a correspondent degree of intimacy, and storing data records associated therewith in said multi-facet profile database.

15. The method as claimed in claim 14, wherein said receiving from said first member an identification of at least one profile facet among said identifiable profile facets comprises:
enabling said first member to hierarchically identify said at least one profile facet by providing at least one of an indication of a given degree of intimacy and an identification of a given profile facet associated with said given degree of intimacy, where said at least one profile facet is deemed to include all profile facets associated with a degree of intimacy lower or equal to said given degree of intimacy among said plurality of profile facets.

16. The method as claimed in claim 1, wherein said segregation process is carried out by said first member.

17. The method as claimed in claim 1, wherein said segregation process is carried out automatically as a function of segregation criteria defined by said first member.

18. A system for customizing a relationship between members of a social network based on a multi-facet member profile, the system comprising:
a multi-facet profile generator for receiving profile data associated with a first member, and for segregating at least a part of said profile data into a plurality of identifiable profile facets, where said multi-facet profile generator is adapted to be connected to a multi-facet profile database for storing therein data records associated with said plurality of identifiable profile facets;
a relationship parameters receiving module for receiving relationship parameters comprising: an identification of at least one other member of said social network, an identification of at least one profile facet among said identifiable profile facets, and sharing parameters defining access privileges to said at least one profile facet by said at least one other member; and
a relationship customizing module adapted to be connected to said relationship parameters receiving module for generating, as a function of said relationship parameters, relationship data records comprising data records allowing for determining, for each one of said at least one other member, access privileges associated with each one of said at least one profile facet, where said relationship customizing module is adapted to be connected to a relationship database for storing therein said generated data records.

19. The system as claimed in claim 18, wherein said segregating at least a part of said profile data into a plurality of identifiable profile facets comprises associating with each one of said profile facets a correspondent degree of intimacy, and storing data records associated therewith in said multi-facet profile database.

20. The system as claimed in claim 19, wherein said relationship parameters receiving module is adapted to be connected to said multi-facet profile database for enabling said first member to hierarchically identify said at least one profile facet by providing at least one of an indication of a given degree of intimacy and an identification of a given profile facet associated with said given degree of intimacy, where said at least one profile facet is deemed to include all profile facets associated with a degree of intimacy lower or equal to said given degree of intimacy among said plurality of profile facets.

21. The system as claimed in claim 18, wherein said relationship parameters further comprise an identification of at least one interactional medium among a plurality of interactional mediums provided for use over a social data network, and use restriction parameters in connection with said at least one interactional medium and said at least one other member, wherein said generated relationship data records further comprise data records allowing for determining, for each one of said at least one other member, use privileges associated with each one of said at least one interactional medium in order to interact with said first member or said first member's contacts.

22. The system as claimed in claim 18, wherein said relationship parameters further comprise an identification of contacts of said first member over a social network and visibility parameters in connection with said at least one other member and said first member's contacts, wherein said generated relationship data records further comprise data records allowing for determining, for each one of said at least one other member, visibility privileges associated with each one of said first member's contacts.

23. The system as claimed in claim 18, wherein said relationship parameters further comprise an indication if system-generated alerts associated with said first member are allowed or restricted to be transmitted to said at least one other member, wherein said generated relationship data records further comprise data records allowing for determining, for each one of said at least one other member, transmitted alert privileges associated with said first member.

24. The system as claimed in claim 18, wherein said relationship parameters further comprise an indication if system-generated alerts transmitted thereto and associated with said at least one other member are allowed or restricted, wherein said generated relationship data records further comprise data records allowing for determining received alert privileges associated with each one of said at least one other member.

25. A system for managing sharing of information over a social network, the system comprising:
a relationship database comprising data records comprising data records allowing for determining, for each one of at least one profile facet among a plurality of profile facets of a first member, access privileges associated with each one of at least one other member.
an inquiring module adapted to be connected to said relationship database; and
a multi-facet profile access securing module adapted to be connected to said social network, to said inquiring module and to a multi-facet profile database comprising said plurality of profile facets of said first member, where said multi-facet profile access securing module receives a request originating from said social network to access a given profile facet among said plurality of profile facets by a given member, generates and transmits an inquiring request to said inquiring module for inquiring if said given member is allowed to access said given profile facet, receives an inquiring response thereof, and if required, maps said given member to said given profile facet stored in said multi-facet profile database.

26. The system as claimed in claim 25, wherein said data records stored in said relationship database further comprise data records allowing for determining, for each one of said at least one other member, use privileges associated with each one of at least one interactional medium among a plurality of interactional mediums provided for use over said social data network, the system further comprising:
an interactional medium enabling module adapted to be connected to said social network, to said inquiring module and to said plurality of interactional mediums, where said interactional medium enabling module receives a request originating from said social network to enable a given member to interact with said first member using a given interactional medium among said plurality of interactional mediums, generates and transmits an inquiring request to said inquiring module for inquiring if said given member is allowed to interact with said first member using said given interactional medium, receives an inquiring response thereof, and if required, maps said given member to said given interactional medium.

27. The system as claimed in claim 25, wherein said data records stored in said relationship database further comprise data records allowing for determining, for each one of said at least one other member, visibility privileges associated with each one of contacts of said first member, the system further comprising:
a member's contacts visibility securing module adapted to be connected to said social network, to said inquiring module and to a database storing profile data associated with contacts of said first member, where said first member's contacts visibility securing module receives a request originating from said social network to enable a given member to have a visibility of a given contact among said first member's contacts, generates and transmits an inquiring request to said inquiring module for inquiring if said given member is allowed to have a visibility of said given contact, and if required, maps said given member to said given contact.

28. The system as claimed in claim 25, wherein said data records stored in said relationship database further comprise data records allowing for determining, for each one of said at least one other member, transmitted alert privileges associated with said first member, the system further comprising
a transmitted alerts controlling module adapted to be connected to said social network, to said inquiring module and to a transmitted alerts database, where said transmitted alerts controlling module receives a request originating from said social network to transmit a given system-generated alert associated with said first member to a given member of said social network, generates and transmits an inquiring request to said inquiring module for inquiring if said given system-generated alert is allowed to be transmitted to said given member, receives an inquiring response thereof, and if required, allows transmission of said given system-generated alert to said given member.

29. The system as claimed in claim 25, wherein said data records stored in said relationship database further comprise data records allowing for determining received alert privileges associated with each one of said at least one other member, the system further comprising:
a received alerts controlling module adapted to be connected to said social network, to said inquiring module and to a received alerts database, where said received alerts controlling module receives a request originating from said social network to allow reception of a given system-generated alert originating from a given member of said social network by said first member, generates and transmits an inquiring request to said inquiring module for inquiring if said given system-generated alert originating from said given member is allowed to be received by said first member, and if required, allows reception of said given system-generated alert by said first member.
